(19) United States
(12) Patent Application Publication
(10) Pub. No.: US 2010/0053472 A1
(43) Pub. Date: Mar. 4, 2010

(54) Image content transmitting server, image display apparatus, image content transmitting method, and image displaying method

(75) Inventors: Shinya Murai, Kanagawa (JP); Masataka Goto, Kanagawa (JP); Kensaku Yamaguchi, Kanagawa (JP); Yasuyuki Nishibayashi, Kanagawa (JP); Hiroshi Kawazoe, Kanagawa (JP)

Correspondence Address: NIXON & VANDERHYE, PC, 901 NORTH GLEBE ROAD, 11TH FLOOR, ARLINGTON, VA, 22203, US

(73) Assignee: KABUSHIKI KAISHA TOSHIBA, Tokyo (JP)

(21) Appl. No.: 12/382,568

(22) Filed: Mar. 18, 2009

(30) Foreign Application Priority Data
Aug. 28, 2008 (JP) 2008-220505

(51) Int. Cl. H04N 5/66; H04N 7/173

(52) U.S. Cl. 348/739; 725/118; 348/E05.133

(57) ABSTRACT

An image content transmitting server includes a remote control service unit that transmits, to an image display apparatus connected via a network, data of a desktop screen displayed on another display apparatus, and receives an input from an input unit connected to the image display apparatus; an image-content transmission service unit that transmits a list of identification information of image contents to the image display apparatus, and transmits the image contents to the image display apparatus, based on the identification information of the image contents included in the list of identification information; and a service advertising unit that advertises services implemented by the remote control service unit and the image-content transmission service unit to the image display apparatus in accordance with a discovery protocol for finding the services.

### CROSS-REFERENCE TO RELATED APPLICATIONS

This application is based upon and claims the benefit of priority from the prior Japanese Patent Application No. 2008-220505, filed on Aug. 28, 2008; the entire contents of which are incorporated herein by reference.

### BACKGROUND OF THE INVENTION

1. Field of the Invention

The present invention relates to an image content transmitting server, an image display apparatus, an image content transmitting method, and an image displaying method.

2. Description of the Related Art

As home LAN becomes widespread, a function of viewing image contents stored in a personal home computer (PC) on another machine connected thereto via the network (hereinafter, “image content viewing function”) is becoming popular. For example, by use of a machine that is compliant with the Digital Living Network Alliance (DLNA) standard, an image content stored in the PC can be viewed on another PC or television via a network.

JP-A 2008-118181 (KOKAI) describes a communication apparatus technology for receiving and displaying image data from different servers by different communication channels in accordance with corresponding coding systems.

Meanwhile, a software program that runs on a PC for displaying a screen of another PC connected thereto via a network and remotely controlling the function of the displayed PC is available. This software program allows the image content to be viewed on the image display apparatus as long as the image content can be decoded and displayed on a PC, even if the image display apparatus cannot directly decode and display the content. Such a function is called “remote controlling”. When this function is used, the quality of the image including the frame rate may be degraded.

If an image content cannot be reproduced on an image display apparatus but the apparatus is provided with the image content viewing function and the remote controlling function, the content can be viewed by using the remote controlling function.

Conventionally, however, the image content viewing function and the remote controlling function are completely independent of each other. Therefore, the user needs to find services and set up access controls in separate procedures, which makes the procedures complicating. For example, on an image content transmitting server that runs on Windows Vista (registered trademark), the user has to set up the accessibility separately for Windows (registered trademark) Media Connect, which is an example of the image content viewing function, and for Remote Desktop, which is an example of the remote controlling function.

For this reason, when the content cannot be viewed by using the image content viewing function, the system shifts to the remote controlling function. Because these functions are realized with different user interfaces, there are many steps be taken to move to the remote controlling function. The user needs to understand the operating procedures for both functions, which is a confusing task for the user.

### SUMMARY OF THE INVENTION

According to one aspect of the present invention, an image content transmitting server includes a remote control service unit that transmits, to an image display apparatus connected via of a network, data of a desktop screen displayed on another display apparatus, and receives an input from an input unit connected to the image display apparatus; an image-content transmission service unit that transmits a list of identification information of image contents to the image display apparatus, and transmits the image contents to the image display apparatus, based on the identification information of the image contents included in the list of identification information that is designated by the input unit connected to the image display apparatus; and a service advertising unit that advertises services implemented by the remote control service unit and the image-content transmission service unit to the image display apparatus in accordance with a discovery protocol for finding the services.

According to another aspect of the present invention, an image display apparatus includes a network interface; a remote control client unit that receives, by network interface from an image content transmitting server connected via a network, data of a desktop screen displayed on another display apparatus connected to the image content transmitting server, outputs the data to a displaying unit of, and transmits an input from an input unit to the image content transmitting server; an image-content reception client unit that receives a list of identification information of image contents from the image content transmitting server, transmits identification information of the image contents input by the input unit and a request for acquiring the image contents to the image content transmitting server, receives the image contents from the image content transmitting server, and displays the image contents; and a user interface unit that offers a user interface to select either one of the remote control client unit and the image-content reception client unit.

According to still another aspect of the present invention, an image content transmitting method includes advertising services realized by a remote control service unit and an image-content transmission service unit to an image display apparatus in accordance with a discovery protocol for finding the services; transmitting, by the remote control service unit, to an image display apparatus connected thereto by way of a network, data of a desktop screen displayed on another display apparatus connected to the image content transmitting server; receiving, by the remote control service unit, an input from an input unit connected to the image display apparatus; transmitting, by the image-content transmission service unit, to the image display apparatus a list of identification information of image contents managed by the image content transmitting server; and transmitting, by the image-content transmission service unit, the image contents to the image display apparatus, based on the identification information of the image contents included in the list of identification information that is designated by the input unit connected to the image display apparatus.

According to still another aspect of the present invention, an image displaying method includes displaying a selection screen from which either one of a remote control client function and an image content reception client function is selected; obtaining information input from the selection screen; executing either one of the remote control client function and the image content reception client function based on the information obtained at the obtaining the information; receiving, by use of the remote control client function, by way of the network interface from an image content transmitting server connected thereto by way of a network, data of a desktop screen displayed on another display apparatus connected to the image content transmitting server, and outputting the data to a displaying unit of the image display apparatus; transmitting, by use of the remote control client function, an input from an input unit connected to the image display apparatus to the image content transmitting server; receiving, by use of the image content reception client function, a list of identification information of image contents managed by the image content transmitting server from the image content transmitting server; transmitting, by use of the image content reception client function, identification information of the image contents input by the input unit and a request for acquiring the image contents to the image content transmitting server; and receiving, by use of the image content reception client function, the image contents from the image content transmitting server and displaying the image contents.

### BRIEF DESCRIPTION OF THE DRAWINGS

FIG. 1 is a diagram for showing the structure of a system on which an integrated server 100 and an image display apparatus 200 run;

FIG. 2 is a diagram for explaining blocks of functions of the integrated server 100 and the image display apparatus 200;

FIG. 3 is a sequence diagram for explaining a procedure of finding services;

FIG. 4 is a diagram for showing an exemplary structure of a message M33 when the UPnP is used;

FIG. 5 is a diagram for showing messages in detail in a service discovery sequence by use of the UPnP;

FIG. 6 is a diagram for explaining a procedure of controlling access to a service offered by the integrated server 100;

FIG. 7 is a diagram of an example of the message M33 including information regarding the availability of an access controlling unit 130 and the usage of this unit;

FIG. 8 is a sequence diagram for explaining a process in which an image-content transmitting server unit 110 offers an image content for viewing;

FIG. 9 is a diagram for explaining a process of allowing for the viewing of an image content when the integrated server 100 is remotely controlled by the image display apparatus 200; and

FIG. 10 is a diagram for showing an example of a screen displayed on a displaying unit 260 of the image display apparatus 200.

### DETAILED DESCRIPTION OF THE INVENTION

An image content transmitting server sends an image content to an image display apparatus connected thereto by way of a network. Then, by use of the image content viewing function, the image display apparatus reproduces the image contents so that the user can view the image. Examples of the image display apparatuses include a PC and a television connected to the server by way of a network.

In such a system, some contents may not be viewable, depending on the displaying capacity of the image display apparatus and the frequency range of the network between the transmitting server and the image display device. The displaying capacity of the image display apparatus refers to, for example, the size of an image that can be displayed, the bit rate of a moving image, and an image format.

More specifically, if the link speed of the IEEE 802.11g-standard wireless LAN is set to 10 Mbps due to the condition of the radio wave to the access point, an MPEG-2 content encoded at 12 Mbps cannot be transmitted or received on this LAN.

Furthermore, if the image display apparatus can decode and display MPEG-2 image contents only, MPEG-4 image contents cannot be viewed on this device. If the image display apparatus can decode and display MPEG-2 SD-resolution image contents only, MPEG-2 HD-resolution image contents cannot be viewed.

On the other hand, by use of the remote controlling function, a desktop screen displayed on a PC can be sent to an image display apparatus, and thereby the image content that is being reproduced on the PC can be viewed on the image display apparatus. The “desktop screen” refers to a screen that is displayed on a display device by a PC or the like. The desktop screen may be the entire screen displayed by the PC. For example, if a multi-window system is implemented by an OS such as Windows (registered trademark), the entire image that is displayed on the image display apparatus by the OS may be referred to as a desktop screen.

A PC incorporating Windows Vista (registered trademark) is a system that has both the image content viewing function and the remote controlling function. On Windows Vista (registered trademark), Windows (registered trademark) Media Connect corresponds to the image content viewing function, while Remote Desktop corresponds to the remote controlling function.

More specifically, of two PCs incorporating Windows Vista (registered trademark), one PC operates as a server of the Windows (registered trademark) Media Connect function and also as a server of the Remote Desktop function. The other PC operates as a client of the Windows (registered trademark) Media Connect function and also as a client of the Remote Desktop function.

In such a system, if the image content can be transferred and displayed as it is, the Windows (registered trademark) Media Connect function is used. If the image content cannot be transferred and displayed as it is, the Remote Desktop function is used to make the image content viewable by use of a suitable function.

When Windows Vista (registered trademark) switches from the Windows (registered trademark) Media Connect function to the Remote Desktop function, the Remote Desktop icon should be found from an application selecting menu on Windows, and then an address of a PC to be accessed should be input. A Remote Desktop connection can be thereby established. This is based on the premise that the user understands that such an operation is required and knows how to execute the operation.

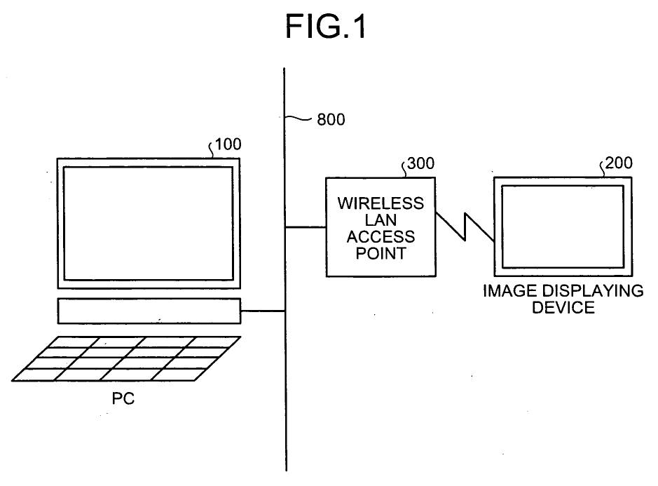

FIG. 1 is a diagram for showing the structure of a system on which the integrated server 100 and the image display apparatus 200 according to the present embodiment run. The integrated server 100 is connected to a wireless LAN (Local Area Network) access point 300 by way of a network 800. The wireless LAN access point 300 is connected to the image display apparatus 200 by radio. The image display apparatus 200 may be directly connected to the network 800 without being connected to the wireless LAN access point 300.

The integrated server 100 realizes the image content transmitting server function and the remote controlling function. By use of the image content transmitting server function, the integrated server 100 operates as a server of the image content viewing function.

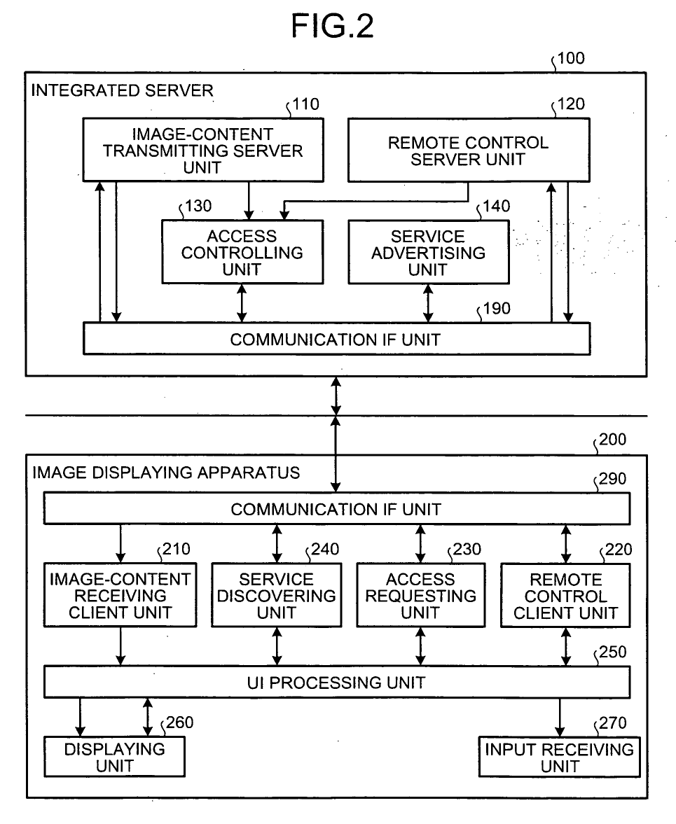

FIG. 2 is a diagram for explaining the function blocks of the integrated server 100 and the image display apparatus 200 illustrated in FIG. 1. In the following description, the integrated server 100 and the image display apparatus 200 communicate with each other by the Internet protocol, but any other communication protocol may be adopted for the present embodiment.

The integrated server 100 includes the image-content transmitting server unit 110, a remote control server unit 120, the access controlling unit 130, a service advertising unit 140, and a communication interface (IF) unit 190.

The image-content transmitting server unit 110 realizes the function of a server in the image content transmitting function. The image-content transmitting server unit 110 sends a list of image content identification information to the image display apparatus 200. Based on the image content identification information input by an input receiving unit 270 of the image display apparatus 200, the image-content transmitting server unit 110 also sends the corresponding image content back to the image display apparatus 200.

The remote control server unit 120 sends the data of a screen displayed on a not-shown displaying device that is connected to the integrated server 100, to the image display apparatus 200. The screen displayed on the displaying device may be a desktop screen. The remote control server unit 120 further receives data input by the input receiving unit 270 of the image display apparatus 200, and executes a process in accordance with the input data.

The access controlling unit 130 determines whether to accept a request for access to the image-content transmitting server unit 110 and the remote control server unit 120. Where there is more than one image display apparatus that is connected to the integrated server 100, the access controlling unit 130 sorts and manages the determination results in accordance with the identification information of individual image display apparatuses.

The service advertising unit 140 advertises the functions (services) realized by the image-content transmitting server unit 110 and the remote control server unit 120 to the image display apparatus 200 by a discovery protocol. The communication IF unit 190 is an interface across which communications are established with the image display apparatus 200 and the like by way of the network 800.

The image display apparatus 200 includes an image-content receiving client unit 210, a remote control client unit 220, an access requesting unit 230, a service discovering unit 240, a user interface (UI) processing unit 250, the displaying unit 260, the input receiving unit 270, and a communication IF unit 290. According to the present embodiment, the displaying unit 260 and the input receiving unit 270, or either one of them, may be provided outside the image display apparatus 200.

The image-content receiving client unit 210 receives the list of the image content identification information managed by the integrated server 100. The image-content receiving client unit 210 also sends the image content identification information input by the input receiving unit 270 and a request for an image content corresponding to this identification information to the integrated server 100. The image-content receiving client unit 210 further receives the image content from the integrated server 100, and displays it on the displaying unit 260.

The remote control client unit 220 receives the data of the screen displayed on the displaying device that is connected to the integrated server 100. This screen may be a desktop screen. The remote control client unit 220 outputs the received screen data to the displaying unit 260 to display on the displaying unit 260. The remote control client unit 220 also sends the data input by the input receiving unit 270 to the remote control server unit 120 of the integrated server 100.

The access requesting unit 230 makes a request for access to the image-content transmitting server unit 110 or the remote control server unit 120 of the integrated server 100. The service discovering unit 240 receives information on the functions realized by the integrated server 100 from the service advertising unit 140 of the integrated server 100, and obtains information on details of the function and the usage of the function. According to the present embodiment, the functions realized by the integrated server 100 may be also referred to as “services”.

The UI processing unit 250 generates a screen to be displayed on the displaying unit 260. The UI processing unit 250 generates the screen to reproduce the image content received by the image-content receiving client unit 210. The UI processing unit 250 also generates a screen to display the desktop screen received by the remote control client unit 220. The screen for displaying the desktop screen can be the same as the desktop screen. The UI processing unit 250 may generate a screen to prompt for instructions to be given to the functions of the image display apparatus 200.

The UI processing unit 250 outputs the data input by the input receiving unit 270 to the remote control client unit 220, the access requesting unit 230, the service discovering unit 240, and the like. The signal input from the input receiving unit 270 and processed by the UI processing unit 250 is a signal input by the user on the input receiving unit 270 in accordance with the screen created by the UI processing unit 250.

The displaying unit 260 displays a screen created by the UI processing unit 250. The displaying unit 260 displays a screen that shows an image content, a desktop screen transmitted by the integrated server 100, or the like.

The input receiving unit 270 receives an instruction that is input to the image display apparatus 200. The instruction received by the input receiving unit 270 relates to a function of the image display apparatus 200 or a function realized by the integrated server 100.

The communication IF unit 290 is an interface for communicating with the integrated server 100 by way of a network.

### <Procedure of Discovering Services>

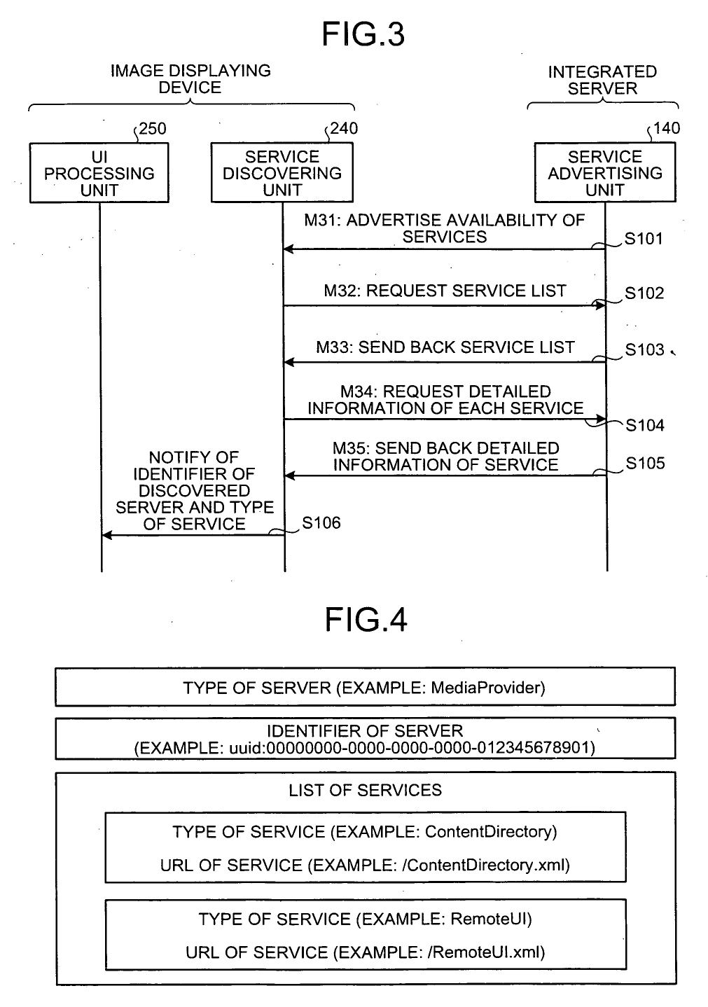

FIG. 3 is a sequence diagram for explaining the procedure of discovering services. The service advertising unit 140 of the integrated server 100 advertises the two services of the server, i.e. the image content transmission and the remote control, to the image display apparatus 200 by use of a service discovery protocol.

At step S101 of FIG. 3, the service advertising unit 140 transmits to the service discovering unit 240 a message M31 that advertises the availability of services. It is preferable that the message M31 includes identification information of the integrated server 100. The message M31 is multicast or broadcasted to transmit to an unspecified number of clients.

After step S101, the system proceeds to step S102, the service discovering unit 240 that has received the message M31 at step S101 sends a message M32 to the service advertising unit 140 to request a list of services available on a machine that advertises the service availability in the message M31.

The system proceeds from step S102 to step S103, where the service advertising unit 140 that has received the message M32 at step S102 transmits the list of services available on the integrated server 100 to the service discovering unit 240. More specifically, a response message M33 indicating a list including the image content transmission service and the remote control service is transmitted.

The system proceeds from step S103 to step S104, where the service discovering unit 240 of the image display apparatus 200 that has received the message M33 at step S103 sends a message M34 to the service advertising unit 140 to request detailed information of individual services based on the received service list. The detailed information of a service may be information regarding the usage of the service.

The system proceeds from step S104 to step S105. The service advertising unit 140 that has received the message M34 at step S104 sends a response message M35 indicating the detailed information of the service to the service discovering unit 240.

Thereafter, the system proceeds to step S106. The service discovering unit 240 that has received the message M35 at step S105 notifies the UI processing unit 250 of the identification information of the discovered integrated server 100 and the information regarding types of the services available on the integrated server 100.

After step S106, the UI processing unit 250 creates a screen presenting the available services to show to the user and displays the screen on the displaying unit 260. In this manner, the user selects a service, a machine that is to receive the service, and the like from the presented information by use of the input receiving unit 270. The selected information is sent to the UI processing unit 250.

In the above process, the receiver of a message sends the next message to the sender of the previous message. Thus, even in a system in which multiple image display apparatuses 200 are arranged, an image display apparatus 200 that receives a message can exchange messages with the integrated server 100.

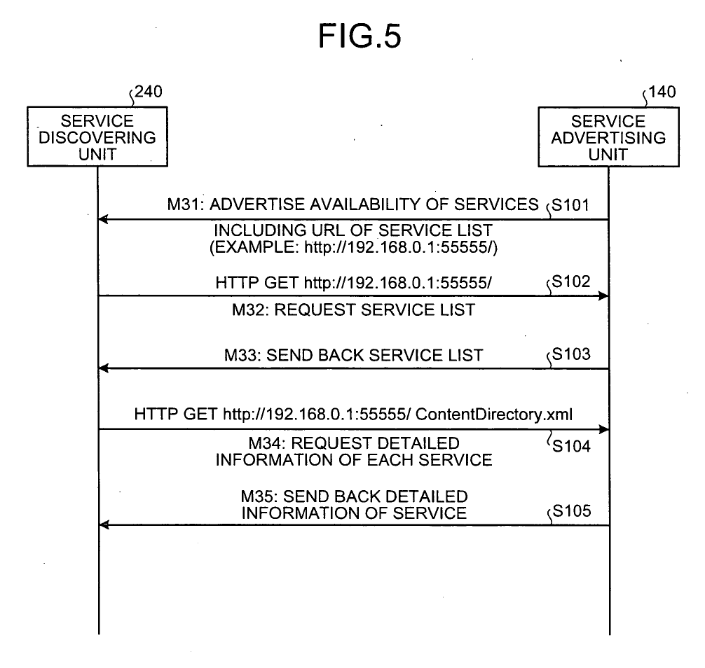

The process at steps S101 through S105 in FIG. 3 may be realized, for example, by Universal Plug and Play (UPnP). FIG. 4 is a diagram for showing an example structure of the message M33 when UPnP is adopted. The message M33 in FIG. 4 includes information regarding “type of server”, “identifier of server”, and “list of services”. The list of services further includes information in which each service is associated with a URL of the service.

FIG. 5 is a diagram for showing the details of the messages in a service discovery flow when the UPnP is adopted. The details of the messages issued at steps S101, S102, and S104 in FIG. 3 are presented. In the message M31, “http://192.168.0.1:55555/” is included as a URL of the list of services.

The message M32 includes “HTTP GET”, in which “http://192.168.0.1:55555/” is presented as an argument. The message M34 includes “HTTP GET”, in which “http://192.168.0.1:55555/ContentDirectry.xml” is presented as an argument.

According to the embodiment illustrated in FIGS. 3 to 5, the image display apparatus 200 can discover any service of the integrated server 100 that offers the image content transmission service and the remote control service, in accordance with a single discovery protocol. Thus, the user can omit some steps from the process of viewing the image content by using a suitable one of the two services.

### <Access Control Procedure>

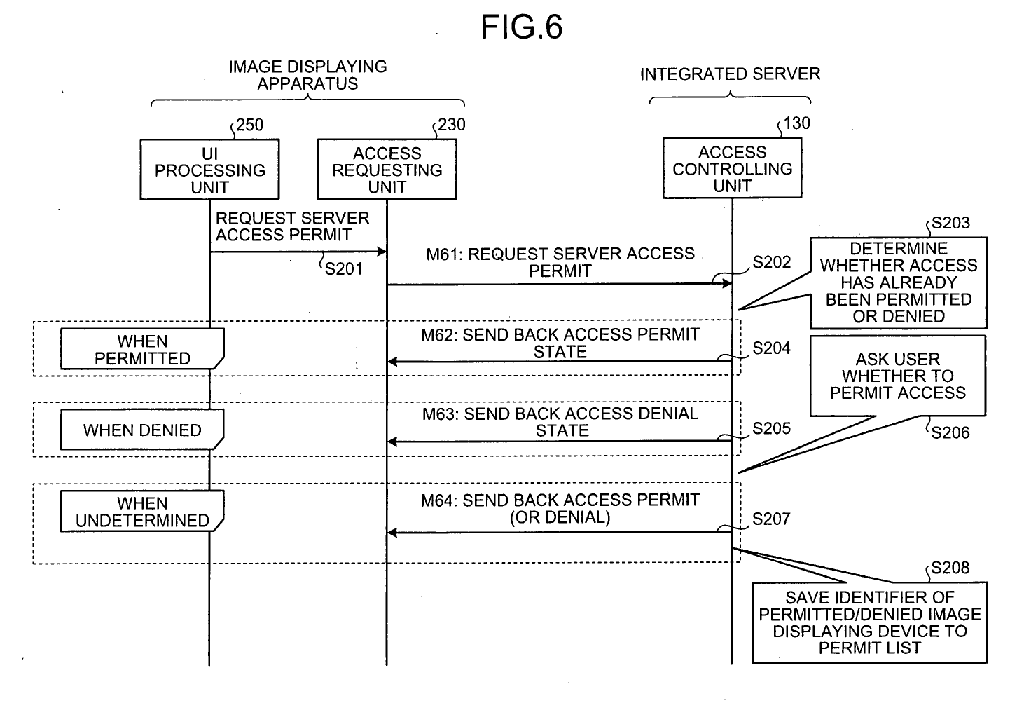

FIG. 6 is a diagram for explaining the procedure of controlling access to a service offered by the integrated server 100. Based on the information input by the user through the input receiving unit 270, the access requesting unit 230 requests access to the discovered integrated server 100, in response to which access permission or denial is issued.

At step S201 in FIG. 6, the UI processing unit 250 outputs to the access requesting unit 230 the information input to the input receiving unit 270 by the user. This output information is a request for a permit to access the integrated server 100.

After step S201, the system proceeds to step S202. The access requesting unit 230 outputs to the access controlling unit 130 a message M61, which is a request for a permit to access the integrated server 100.

Thereafter, the system proceeds to step S203, where the access controlling unit 130 determines whether access has already been permitted or denied for the image display apparatus 200 that transmits the message M61 at step S202. The determination is made in accordance with an access permit list.

When the image display apparatus 200 has been permitted to have access, the system proceeds to step S204. When the access has been denied, the system proceeds to step S205. If the determination has not been made, the system proceeds to step S206.

When the system proceeds from step S203 to step S204, the access controlling unit 130 transmits to the access requesting unit 230 a message M62 indicating that the access has already been permitted. When the system proceeds from step S203 to step S205, the access controlling unit 130 transmits to the access requesting unit 230 a message M63 indicating that the access has already been denied.

When the system proceeds from step S203 to step S206, a screen prompting to enter whether the access should be permitted or denied is displayed on the displaying device connected to the integrated server 100. Based on this screen, the user enters an instruction of a permit or denial regarding the access from the image display apparatus 200 to the integrated server 100.

After step S206, the system proceeds to step S207. The access controlling unit 130 transmits to the access requesting unit 230 a message M64 indicating access permit or denial in accordance with the instruction input at step S206.

The system proceeds to step S208 thereafter, where the access controlling unit 130 updates the access permit list in accordance with the instruction input at step S206.

The access permit list includes, for example, the MAC address of the communication IF unit 290 of the image display apparatus 200 associated with access permit/denial information. The MAC address is obtained through the communication with the image display apparatus 200. The access permit list may be updated, for example, when the user makes a determination at step S206. The information included in this access permit list is referred to by the image-content transmitting server unit 110 and the remote control server unit 120 of the integrated server 100.

The access permit list may be such that each image display apparatus is associated with the access permit/denial information separately for the image content viewing function and for the remote controlling function. In this manner, the access permit/denial information can be managed for individual image display apparatuses with respect to the image content viewing function and to the remote controlling function.

The access permit list may be stored in a memory device that is not shown. The access permit list may be otherwise stored in a computer-readable information recording medium and subjected to the processing by the integrated server 100 when the information recording medium is inserted to a drive device or the like.

In the procedures described in the flowcharts of FIGS. 3 and 5, the image display apparatus 200 needs to obtain and keep in advance the information that the integrated server 100 discovered in accordance with the discovery protocol has the access controlling unit 130 and also the information regarding the usage of this access controlling unit 130. In other words, if the image display apparatus 200 does not have information regarding the usage of the access controlling unit 130 of the integrated server 100, this access controlling unit 130 cannot be used.

For this reason, at step S103 in FIG. 3, when a service available on the integrated server 100 is advertised, information regarding the usage of the access controlling unit 130 should be advertised so that the image display apparatus 200 can suitably use this access controlling unit 130.

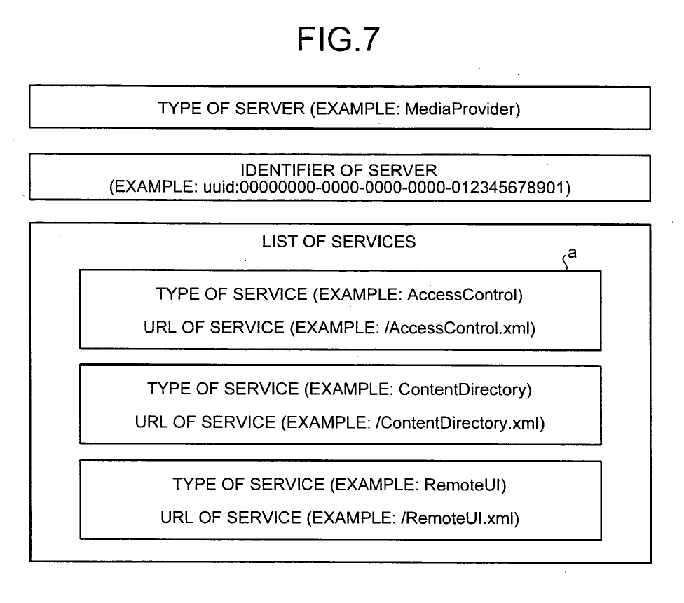

FIG. 7 is a diagram for showing an example of the message M33 including the availability of the access controlling unit 130 and its usage. The information a in this drawing corresponds to the information regarding the availability of the access controlling unit 130 and the usage.

### <Image Content Viewing Process>

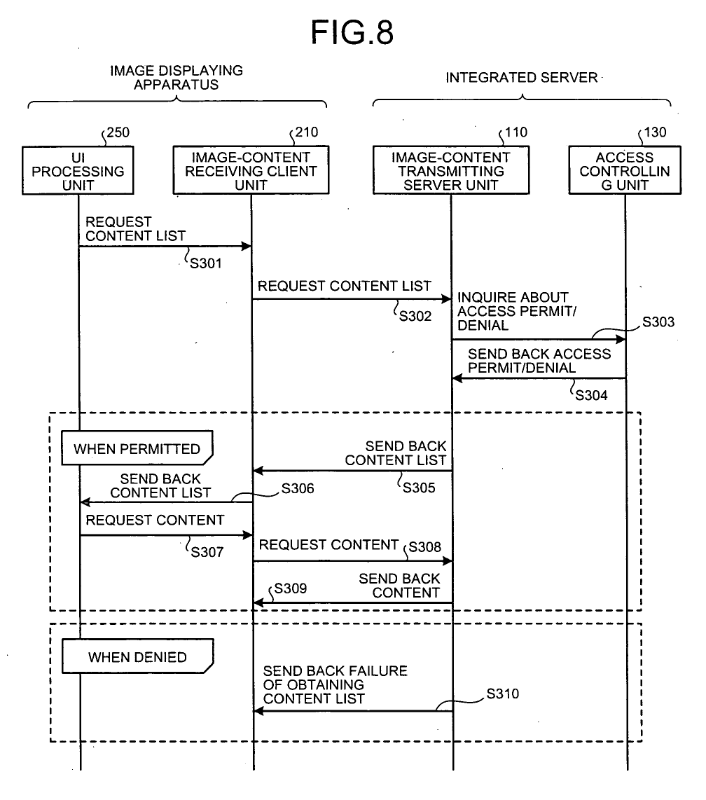

FIG. 8 is a sequence diagram for explaining a process in which the image-content transmitting server unit 110 offers an image content for viewing in response to the user's instruction. This process should be performed after, for example, the list of services available on the integrated server 100 is presented by the process illustrated in FIG. 3.

At step S301 in FIG. 8, the UI processing unit 250 outputs to the image-content receiving client unit 210 a request for obtaining a list of image contents managed by the integrated server 100, based on an instruction indicating that the service selected by the user is the image content transmission service. This request is output when the user selects the image content viewing service based on the list of services that is displayed on the displaying unit 260 by the UI processing unit 250.

After step S301, the system proceeds to step S302, where the image-content receiving client unit 210 outputs to the image-content transmitting server unit 110 a request for obtaining the list of image contents managed by the integrated server 100 in accordance with the request made at step S301.

Thereafter, the system proceeds to step S303, where the image-content transmitting server unit 110 outputs an inquiry regarding the access permit/denial to the access controlling unit 130. In response to this inquiry, the access controlling unit 130 acquires the MAC address of the image display apparatus from which the access is made, from the communications including the request made at step S302.

The access controlling unit 130 further browses the access permit list and refers to the state of the access permit/denial for the acquired MAC address. When the information of the access permit/denial for the MAC address is included in the access permit list, and also when the information of the access permit/denial indicates “permit”, the image display apparatus 200 is allowed to use the integrated server 100. On the other hand, when the information of the access permit/denial for the MAC address is “denial”, or when there is no corresponding MAC address on the access permit list, the access controlling unit 130 notifies the image display apparatus of the failure of obtaining the content list.

Thereafter, the system proceeds to step S304, where the access controlling unit 130 outputs to the image-content transmitting server unit 110 an access permit/denial response to the inquiry made at step S303. This access permit/denial response is acquired by the access controlling unit 130 in response to the inquiry of step S303.

After the process of step S304, the system proceeds to either step S305 or S310 based on the information related to the access permit/denial acquired in response to the inquiry of step S303. More specifically, when the access permit/denial information indicates “access permitted”, the system proceeds to step S305. When the access permit/denial information indicates “access denied”, the system proceeds to step S310.

Then, at step S305, the image-content transmitting server unit 110 sends to the image-content receiving client unit 210 the list of identification information of the image contents offered by the integrated server 100. The list of image content identification information may be obtained by a search for image contents offered by the integrated server 100.

Thereafter, the system proceeds to step S306, where the image-content receiving client unit 210 outputs to the UI processing unit 250 a response including the list of image content identification information. This response corresponds to the list of contents output at step S301.

Based on the list of image contents included in the response output at step S306, the UI processing unit 250 generates a screen to display the list on the displaying unit 260, and the displaying unit 260 displays this screen. In this manner, the user can designate the identification information of a target image content from the displayed list by way of the input receiving unit 270.

After step S306, the system proceeds to step S307, where the UI processing unit 250 outputs a request for the image content designated by the user to the image-content receiving client unit 210. This request should include the identification information of the designated image content.

Thereafter, the system proceeds to step S308, where the image-content receiving client unit 210 transmits a request for obtaining the image content to the image-content transmitting server unit 110. This request should include the identification information of the image content. Based on this request, the image-content transmitting server unit 110 selects an image content that has the identification information included in the request from the image contents that are stored.

Thereafter, the system proceeds to step S309, where the image-content transmitting server unit 110 transmits to the image-content receiving client unit 210 the image content data. The image-content receiving client unit 210 reproduces the received image content, and the UI processing unit 250 displays the content on the displaying unit 260. Finally, the user can view the image content. When the image content is coded, the image-content receiving client unit 210 may decode the image content.

On the other hand, when the system proceeds to step S310 after step S304, the image-content transmitting server unit 110 outputs to the image-content receiving client unit 210 a list acquisition failure to notify that the list of image contents cannot be obtained.

The image content transmitted by the image-content transmitting server unit 110 may be a moving image or a still image. The Real-time Transport Protocol (RTP) or Hypertext Transport Protocol (HTTP) may be adopted as the transmission/reception protocol, or any other transport protocol may be adopted.

### <Remote Controlling Process>

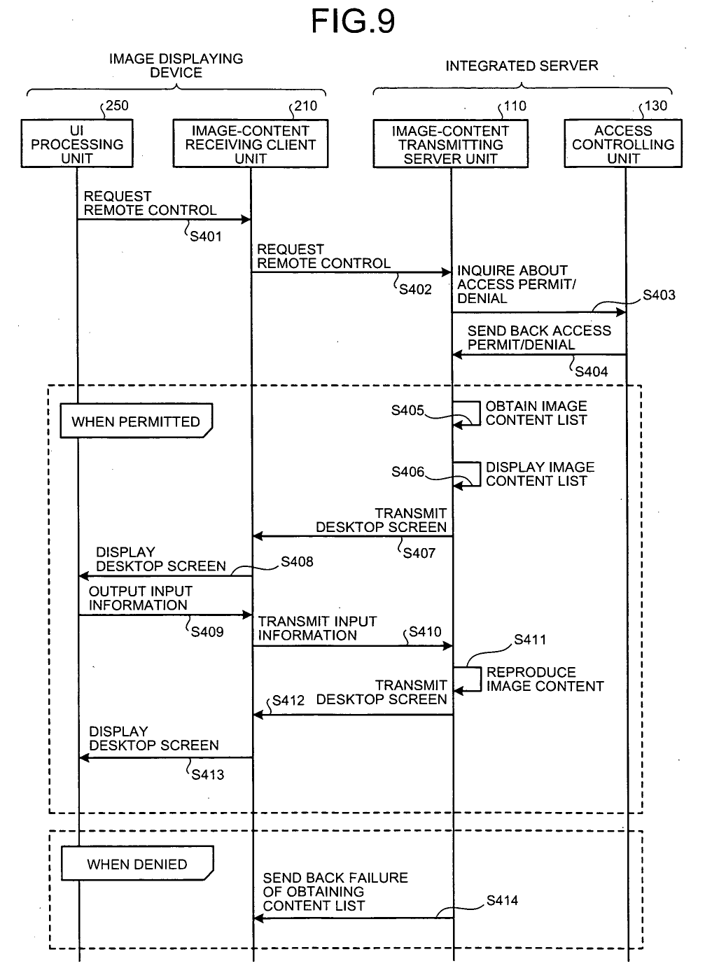

FIG. 9 is a diagram for explaining a process of a process of allowing for the viewing of an image content when the integrated server 100 is remotely controlled by the image display apparatus 200 by way of the remote control server unit 120. The process of FIG. 9 should be conducted after the list of services available on the integrated server 100 is displayed as a result of the process of FIG. 3, for example.

At step S401 in FIG. 9, the UI processing unit 250 outputs to the remote control client unit 220 a request of outputting a message to request the start of the remote control. This request is output when the user selects the remote controlling function from the list of services displayed on the displaying unit 260 by the UI processing unit 250.

After step S401, the system proceeds to step S402, where the remote control client unit 220 outputs to the remote control server unit 120 a request message for starting the remote control in response to the request made at step S401.

Thereafter, the system proceeds to step S403, where the remote control server unit 120 outputs an access permit/denial inquiry to the access controlling unit 130. Based on this inquiry, the access controlling unit 130 acquires the MAC address of the image display apparatus from which the access is made from the communications including the request made at step S402.

The access controlling unit 130 further browses the access permit list, and refers to the access permit/denial state corresponding to the acquired MAC address. When the information regarding the access permit/denial state corresponding to the MAC address is included in the access permit list, and when the information on the access permit/denial indicates “permit”, the use of the integrated server 100 is permitted for the image display apparatus 200. On the other hand, when the information regarding the access permit/denial corresponding to the MAC address indicates “denial”, or when no corresponding MAC address is included in the access permit list, the image display apparatus is notified that the content list cannot be acquired.

After step S403, the system proceeds to step S404, where the access controlling unit 130 outputs an access permit/denial response to the remote control server unit 120, in response to the inquiry made at step S403. This access permit/denial response is acquired by the access controlling unit 130, based on the inquiry of step S403.

After the process at step S404, the system proceeds to either step S405 or S410 in accordance with the information regarding the access permit/denial obtained in response to the inquiry of step S403. More specifically, when the access permit/denial information indicates “access permitted”, the system proceeds to step S405. When the access permit/denial information indicates “access denied”, the system proceeds to step S410.

When the system proceeds from step S404 to step S405, the remote control server unit 120 acquires the list of identification information of the image contents offered by the integrated server 100. Thereafter, the system proceeds to step S406, where the remote control server unit 120 displays the list of image content identification information acquired at step S405 on the displaying device connected to the integrated server 100.

Thereafter, the system proceeds to step S407, where the remote control server unit 120 transmits to the remote control client unit 220 the data of the screen displayed at step S406. This screen is a desktop screen, for example. The transmitted screen data may be a compressed image of the desktop screen. The transmitted screen data may be a moving image or a still image. The data of the desktop screen may be acquired at regular time intervals, or when any change is made to the desktop screen.

After step S407, the system proceeds to step S408, where the remote control client unit 220 outputs to the UI processing unit 250 the desktop screen data transmitted at step S407. Based on this data, the UI processing unit 250 displays the desktop screen on the displaying unit 260. When the desktop screen data is compressed, the remote control client unit 220 decodes the data.

Thereafter, at step S409, the UI processing unit 250 outputs to the remote control client unit 220 the information input by the input receiving unit 270 of the image display apparatus 200. This information may be coordinate data on the screen displayed on the displaying unit 260, and may be based on the information input by way of not-shown devices such as a mouse and a keyboard.

More specifically, the input information may be a request for moving the mouse cursor or for an operation corresponding to pressing the mouse button. The request for moving the mouse cursor may be information on the relative or absolute position of the mouse cursor on the displayed screen. The input information may also be a request for an operation that is made by operating the keyboard, such as a request for an operation corresponding pressing a specific key.

After step S409, the system proceeds to step S410, where the remote control client unit 220 outputs to the remote control server unit 120 the input information that is output at step S409. Thereafter, the system proceeds to step S411. The remote control server unit 120 obtains the identification information of the image content designated by the user from the information of the coordinates corresponding to the desktop screen, based on the input information transmitted at step S410, and reproduces the image content by displaying it on the not-shown displaying device. In this manner, the reproduction of the image content on the desktop screen is realized.

After step S411, the system proceeds to step S412, where the remote control server unit 120 transmits to the remote control client unit 220 the data of the desktop screen. Thereafter, the system proceeds to step S413, where the remote control client unit 220 outputs to the UI processing unit 250 a request for displaying the desktop screen transmitted at step S412. This request should include the data of the desktop screen. In response to this request, the UI processing unit 250 displays the desktop screen on the displaying unit 260. When the data of the desktop screen is compressed, the remote control client unit 220 decodes the data.

### <Procedure of Switching Functions>

The process of switching from the image content viewing function to the remote controlling function in response to the user's instruction is explained below. For example, the user selects a content that the user desires to view by use of the image content viewing function, but the content may not be displayed on the image display apparatus. Such a situation occurs when the image size, the bit rate of the moving image, or the image format that can be displayed on the image display apparatus 200 does not satisfy the specifications required for reproducing the designated image content. The situation may also occur when the available frequency range of the network between the integrated server 100 and the image display apparatus 200 is smaller than the bit rate of the designated image content.

If the information on the image size, the bit rate of the moving image, or the image format is included in the attribute information of the image content, this attribute information should be referred to to determine as to whether the attributes satisfy the display specifications of the image display apparatus 200. When the attribute information of the image content is included in the list of image content identification information, a determination can be made as to whether the display specifications of the image display apparatus 200 are satisfied simply by referring to the attribute information included in the list, without accessing the data of the image content.

Whether the available frequency range of the network is smaller than the bit rate of the image content can be determined by checking whether the reception speed catches up with the display speed when the image display apparatus 200 receives and displays the data of the image content.

When the image content cannot be reproduced by use of the image content viewing function, the user should input an instruction to the input receiving unit 270. The input information is processed by the UI processing unit 250, and thereby the function is switched to the remote controlling function.

By the remote controlling function, the image content designated by the user is reproduced and displayed on the displaying device that is connected to the integrated server 100, and the desktop screen of the displaying device is transmitted to the image display apparatus 200. The user can thereby view the image content.

The frame rate may be reduced depending on the processing capability of the integrated server 100 and the frequency range of the network.

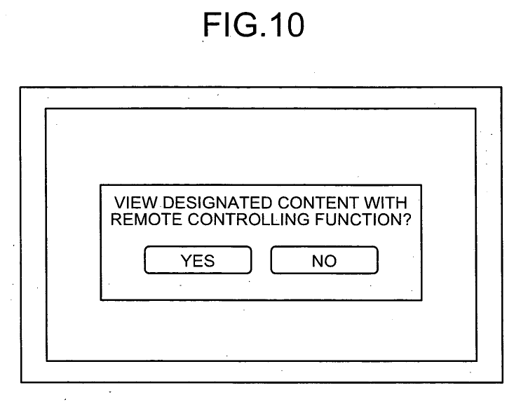

FIG. 10 is a diagram for showing an example of a screen displayed on the displaying unit 260 of the image display apparatus 200. For example, when it is determined that the image content cannot be viewed by use of the image content viewing function due to the above explained conditions or any other conditions, a message such as “view the content by use of remote controlling function” should be presented so that the user can smoothly shift to the viewing with the remote controlling function.

The above message should be presented when the integrated server 100 is provided with both the image-content transmitting server unit 110 and the remote control server unit 120. For this arrangement, a determination should be made as to whether the image content cannot be obtained from an integrated server 100 having an image-content transmitting server unit 110 but not the remote control server unit 120 or from the integrated server 100 having both the image-content transmitting server unit 110 and the remote control server unit 120. When it is determined that the PC has both, the above message should be presented.

The message in FIG. 10 reads “view the designated content with the remote controlling function?”, prompting the user for input. When the user selects and inputs “yes” in response to the message displayed on the screen, the operation of connecting to the remote control server should be initiated.

According to the present embodiment, the access control setting can be made for the image content transmitting function and the remote controlling function at the same time, and the image content can be readily viewed by choosing either one of the functions. Furthermore, on the image display apparatus on which the image content is viewed, the user interface for selecting either one of the image content transmitting function and the remote controlling function is realized by the single program. When the image content cannot be viewed by use of the image content transmitting function, the user interface notifies the user that the remote controlling function should be used so that the workload can be reduced for the user when shifting from the image content transmitting function to the remote controlling function.

The integrated server 100 and the image display apparatus 200 according to the present embodiment may be realized by personal computers (PCs) or the like. The integrated server 100 and the image display apparatus 200 may be implemented by the CPU in accordance with a program stored in a ROM or a hard disk device by using the main memory such as a RAM as a work area.

Various inventions can be achieved by suitably combining the structural components disclosed in the above embodiments. Some components may be omitted from the entire structure of an embodiment. The components of different embodiments may be suitably combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image content transmitting server comprising:
a remote control service unit that transmits, to an image display apparatus connected via a network, data of a desktop screen displayed on another display apparatus, and receives an input from an input unit connected to the image display apparatus;
an image-content transmission service unit that transmits a list of identification information of image contents to the image display apparatus, and transmits the image contents to the image display apparatus, based on the identification information of the image contents included in the list of identification information that is designated by the input unit connected to the image display apparatus; and
a service advertising unit that advertises services implemented by the remote control service unit and the image-content transmission service unit to the image display apparatus in accordance with a discovery protocol for finding the services.

2. The server according to claim 1, further comprising an access controlling unit that controls a determination as to whether to accept a request for access to the remote control service unit and the image-content transmission service unit, based on identification information of the image display apparatus.

3. The server according to claim 2, wherein the access controlling unit advertises availability of the access controlling unit in accordance with the discovery protocol.

4. An image display apparatus comprising:
a network interface;
a remote control client unit that receives, by the network interface from an image content transmitting server connected via a network, data of a desktop screen displayed on another display apparatus connected to the image content transmitting server, outputs the data to a displaying unit, and transmits an input from an input unit to the image content transmitting server;
an image-content reception client unit that receives a list of identification information of image contents from the image content transmitting server, transmits identification information of the image contents input by the input unit and a request for acquiring the image contents to the image content transmitting server, receives the image contents from the image content transmitting server, and displays the image contents; and
a user interface unit that offers a user interface to select either one of the remote control client unit and the image-content reception client unit.

5. The image display apparatus according to claim 4, wherein the remote control client unit receives the data of the desktop screen and displays the desktop screen, when the image-content reception client unit cannot receive the image contents from the image content transmitting server.

6. An image content transmitting method comprising:
advertising services realized by a remote control service unit and an image-content transmission service unit to an image display apparatus in accordance with a discovery protocol for finding the services;
transmitting, by the remote control service unit, to an image display apparatus connected via a network, data of a desktop screen displayed on another display apparatus connected to the image content transmitting server;
receiving, by the remote control service unit, an input from an input unit connected to the image display apparatus;
transmitting, by the image-content transmission service unit, to the image display apparatus a list of identification information of image contents managed by the image content transmitting server; and
transmitting, by the image-content transmission service unit, the image contents to the image display apparatus, based on the identification information of the image contents included in the list of identification information that is designated by the input unit connected to the image display apparatus.

7. An image displaying method comprising:
displaying a selection screen from which either one of a remote control client function and an image content reception client function is selected;
obtaining information input from the selection screen;
executing either one of the remote control client function and the image content reception client function based on the information obtained at the obtaining the information;
receiving, by use of the remote control client function, by way of the network interface from an image content transmitting server connected thereto by way of a network, data of a desktop screen displayed on another display apparatus connected to the image content transmitting server, and outputting the data to a displaying unit of the image display apparatus;
transmitting, by use of the remote control client function, an input from an input unit connected to the image display apparatus to the image content transmitting server;
receiving, by use of the image content reception client function, a list of identification information of image contents managed by the image content transmitting server from the image content transmitting server;
transmitting, by use of the image content reception client function, identification information of the image contents input by the input unit and a request for acquiring the image contents to the image content transmitting server; and
receiving, by use of the image content reception client function, the image contents from the image content transmitting server and displaying the image contents.
